(19) United States
(12) Patent Application Publication
(10) Pub. No.: US 2026/0075034 A1
(43) Pub. Date: Mar. 12, 2026

(54) ACTIVE SYSTEM FOR PARTITIONING GATEID IDENTIFIER SPACE

(71) Applicant: ARRIS Enterprises LLC, Horsham, PA (US)

(72) Inventors: William T. HANKS, Carol Stream, IL (US); Mark A. RICHERT, Wheaton, IL (US)

(73) Assignee: ARRIS Enterprises LLC, Horsham, PA (US)

(21) Appl. No.: 19/105,759

(22) PCT Filed: Sep. 12, 2023
(86) PCT No.: PCT/US2023/032526

§ 371 Date: Feb. 21, 2025

Related U.S. Application Data
(60) Provisional application No. 63/406,190, filed on Sep. 13, 2022.
(60) Provisional application No. 63/406,207, filed on Sep. 13, 2022.

(51) Int. Cl. H04L 61/5038; H04L 61/5061

(52) U.S. Cl. CPC H04L 61/5038; H04L 61/5061

(57) ABSTRACT

A system for managing unique identifiers.

### CROSS REFERENCE TO RELATED APPLICATIONS

The present application claims priority to U.S. Provisional Application No. 63/406,190 filed Sep. 13, 2022, and U.S. Provisional Application No. 63/406,207 filed Sep. 13, 2022, the contents of which are each incorporated herein by reference in their entirety.

### BACKGROUND

The subject matter of this application relates to partitioning an object identifier space.

Cable Television (CATV) services provide content to large groups of customers (e.g., subscribers) from a central delivery unit, generally referred to as a “head end,” which distributes channels of content to its customers from this central delivery unit through an access network comprising a hybrid fiber coax (HFC) cable plant, including associated components (nodes, amplifiers and taps). Modern Cable Television (CATV) service networks, however, not only provide media content such as television channels and music channels to a customer, but also provide a host of digital communication services such as Internet Service, Video-on-Demand, telephone service such as VoIP, home automation/security, and so forth. These digital communication services, in turn, require not only communication in a downstream direction from the head end, through the HFC, typically forming a branch network and to a customer, but also require communication in an upstream direction from a customer to the head end typically through the HFC network.

To this end, CATV head ends have historically included a separate Cable Modem Termination System (CMTS), used to provide high speed data services, such as cable Internet, Voice over Internet Protocol, etc. to cable customers and a video headend system, used to provide video services, such as broadcast video and video on demand (VOD). Typically, a CMTS will include both Ethernet interfaces (or other more traditional high-speed data interfaces) as well as radio frequency (RF) interfaces so that traffic coming from the Internet can be routed (or bridged) through the Ethernet interface, through the CMTS, and then onto the RF interfaces that are connected to the cable company's hybrid fiber coax (HFC) system. Downstream traffic is delivered from the CMTS to a cable modem and/or set top box in a customer's home, while upstream traffic is delivered from a cable modem and/or set top box in a customer's home to the CMTS. The Video Headend System similarly provides video to either a set-top, TV with a video decryption card, or other device capable of demodulating and decrypting the incoming encrypted video services. Many modern CATV systems have combined the functionality of the CMTS with the video delivery system (e.g., EdgeQAM—quadrature amplitude modulation) in a single platform generally referred to an Integrated CMTS (e.g., Integrated Converged Cable Access Platform (CCAP))—video services are prepared and provided to the I-CCAP which then QAM modulates the video onto the appropriate frequencies. Still other modern CATV systems generally referred to as distributed CMTS (e.g., distributed Converged Cable Access Platform) may include a Remote PHY (or R-PHY) which relocates the physical layer (PHY) of a traditional Integrated CCAP by pushing it to the network's fiber nodes (R-MACPHY relocates both the MAC and the PHY to the network's nodes). CableLabs specifications refer to this architecture as a Distributed Access Architecture (DAA) with Flexible MAC Architecture (FMA). Thus, while the core in the CCAP performs the higher layer processing, the R-PHY device in the remote node converts the downstream data sent from the core from digital-to-analog to be transmitted on radio frequency to the cable modems and/or set top boxes, and converts the upstream radio frequency data sent from the cable modems and/or set top boxes from analog-to-digital format to be transmitted optically to the core.

### BRIEF DESCRIPTION OF THE DRAWINGS

For a better understanding of the invention, and to show how the same may be carried into effect, reference will now be made, by way of example, to the accompanying drawings, in which:

FIG. 1 illustrates an integrated Cable Modem Termination System.

FIG. 2 illustrates a distributed Cable Modem Termination System.

FIG. 3 illustrates a system that includes a device identity assignor for managing unique identifiers.

FIG. 4 illustrates a system that includes a device identity assignor for managing unique identifiers.

FIG. 5 illustrates manual provisioning for unique identifiers.

FIG. 6 illustrates automatic provisioning for unique identifiers.

FIG. 7 illustrates unique identifier management.

FIG. 8 illustrates a remote protocol participant for unique identifier management.

FIG. 9 illustrates a network with multiple remote fiber nodes.

FIG. 10 illustrates various GateID spaces.

FIG. 11 illustrates a resource service aggregator assigning GateIDs.

### DETAILED DESCRIPTION

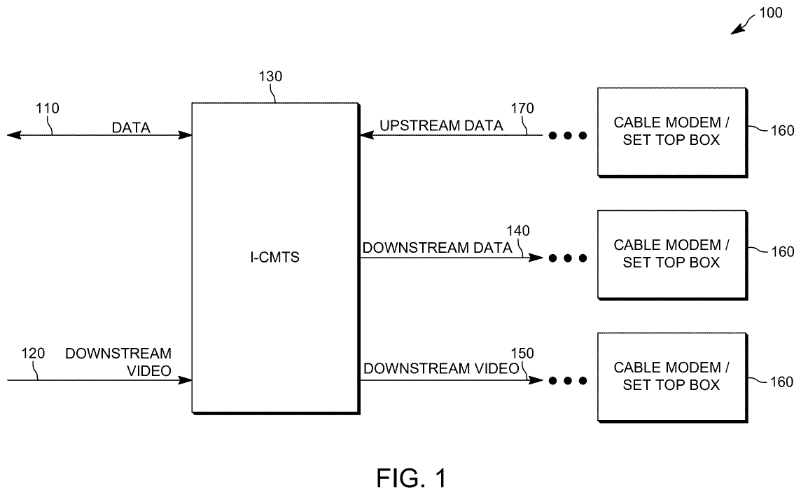

Referring to FIG. 1, an integrated CMTS (e.g., Integrated Converged Cable Access Platform (CCAP)) 100 may include data 110 that is sent and received over the Internet (or other network) typically in the form of packetized data. The integrated CMTS 100 may also receive downstream video 120, typically in the form of packetized data from an operator video aggregation system. By way of example, broadcast video is typically obtained from a satellite delivery system and pre-processed for delivery to the subscriber though the CCAP or video headend system. The integrated CMTS 100 receives and processes the received data 110 and downstream video 120. The CMTS 130 may transmit downstream data 140 and downstream video 150 to a customer's cable modem and/or set top box 160 through a RF distribution network, which may include other devices, such as amplifiers and splitters. The CMTS 130 may receive upstream data 170 from a customer's cable modem and/or set top box 160 through a network, which may include other devices, such as amplifiers and splitters. The CMTS 130 may include multiple devices to achieve its desired capabilities.

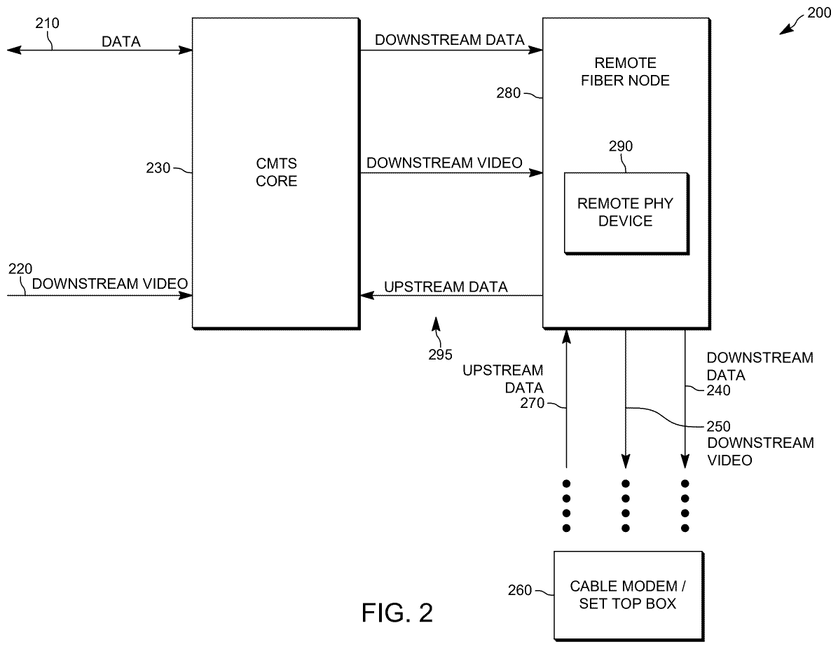

Referring to FIG. 2, as a result of increasing bandwidth demands, limited facility space for integrated CMTSs, and power consumption considerations, a Distributed Cable Modem Termination System (D-CMTS) 200 (e.g., Distributed Converged Cable Access Platform (CCAP)) may be used. CableLabs specifications refer to this architecture as a Distributed CCAP Architecture (DCA) in the Flexible MAC Architecture (FMA) specifications. In general, the CMTS is focused on data services while the CCAP further includes broadcast video services. The D-CMTS 200 distributes a portion of the functionality of the I-CMTS 100 downstream to a remote location, such as a fiber node, using network packetized data. An exemplary D-CMTS 200 may include a remote PHY architecture, where a remote PHY (R-PHY) is preferably an optical node device that is located at the junction of the fiber and the coaxial. In general, the R-PHY often includes the PHY layers of a portion of the system. The D-CMTS 200 may include a D-CMTS 230 (e.g., core) that includes data 210 that is sent and received over the Internet (or other network) typically in the form of packetized data. The D-CMTS 230 is referred to as the Remote MAC Core (RMC) in the Flexible MAC Architecture (FMA) CableLabs specifications. The D-CMTS 200 may also receive downstream video 220, typically in the form of packetized data from an operator video aggregation system. The D-CMTS 230 receives and processes the received data 210 and downstream video 220. A remote fiber node 280 preferably include a remote PHY device (RPD) 290. The RPD 290 may transmit downstream data 240 and downstream video 250 to a customer's cable modem and/or set top box 260 through a network, which may include other devices, such as amplifier and splitters. The RPD 290 may receive upstream data 270 from a customer's cable modem and/or set top box 260 through a network, which may include other devices, such as amplifiers and splitters. The RPD 290 may include multiple devices to achieve its desired capabilities. The RPD 290 primarily includes PHY related circuitry, such as downstream QAM modulators, upstream QAM demodulators, together with psuedowire logic to connect to the D-CMTS 230 using network packetized data. The RPD 290 and the D-CMTS 230 may include data and/or video interconnections, such as downstream data, downstream video, and upstream data 295. It is noted that, in some embodiments, video traffic may go directly to the RPD thereby bypassing the D-CMTS 230. In some cases, the remote PHY and/or remote MACPHY functionality may be provided at the head end.

By way of example, the RPD 290 may covert downstream DOCSIS (i.e., Data Over Cable Service Interface Specification) data (e.g., DOCSIS 1.0; 1.1; 2.0; 3.0; 3.1; and 4.0 each of which are incorporated herein by reference in their entirety), video data, out of band signals received from the D-CMTS 230 to analog for transmission over RF or analog optics. By way of example, the RPD 290 may convert upstream DOCSIS, and out of band signals received from an analog medium, such as RF or linear optics, to digital for transmission to the D-CMTS 230. As it may be observed, depending on the particular configuration, the R-PHY may move all or a portion of the DOCSIS MAC and/or PHY layers down to the fiber node.

The amount of data services supported by DOCSIS based networks over time has been increasing. To support the ever-increasing data capacity needs, the DOCSIS standard has likewise been evolving in a manner to support the increasing data capacity needs. A single-carrier quadrature amplitude modulation (SC-QAM) based transmission of DOCSIS 3.0 is giving way to orthogonal frequency division multiplexing (OFDM) and orthogonal frequency division multiple access (OFDMA) of DOCSIS 3.1, to support greater megabits per second (Mbps) per mega-hertz (MHz) of spectrum. Furthermore, more MHz of radio frequency (RF) spectrum yields more Mbps, thus a wider spectrum, for both downstream (DS) and upstream (US) transmission is another manner in which the DOCSIS standard has evolved. For example, the DOCSIS standard has evolved from (1) 5-85 MHz US with 102-1002 MHz DS supported by DOCSIS 3.0 to (2) 5-204 MHz US with 258-1218 MHz DS of DOCSIS 3.1, and (3) 5-682 MHz US with 108-1794 MHz DS of DOCSIS 4.0. Transmitted spectrum width increase, in DS especially, affects how the network is architected. The DOCSIS 3.1 to DOCSIS 4.0 transition, from 1,218 MHz highest DS frequency to 1,794 MHz highest DS frequency, envisions a change from a centralized access architecture (CAA) to distributed access architecture (DAA), in order to support higher OFDM modulation formats and thus improved spectral density at the DAA nodes.

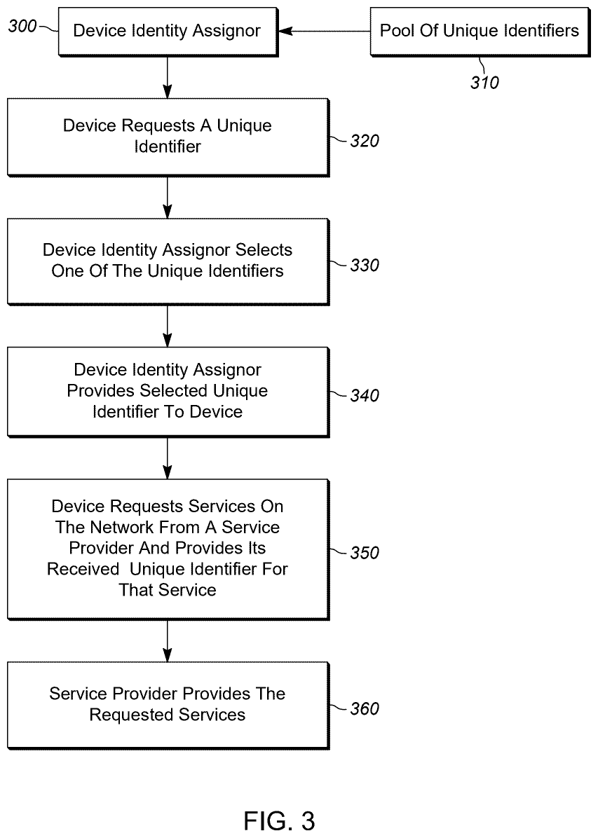

Referring to FIG. 3, the I-CMTS 130 and/or the D-CMTS 230 and/or Remote Fiber Node 280 may include a device identity assignor 300 that maintains a pool of unique identifiers 310 that may be distributed to devices. The pool of unique identifiers 310 has only a limited number of unique identifiers. A cable modem/set top box 160/260 that is in communication with the device identity assignor 300 may request one of the unique identifiers to be provided 320. In response to receiving the request for one of the unique identifiers from a device, the device identity assignor 300 may select 330 one of the unique identifiers from the pool 310. The selected unique identifier 330 is preferably a unique identifier that is not currently being used by any device on the network. In response to the device identity assignor 300 selecting one of the unique identifiers 330, the device identity assignor 300 may provide 340 the selected unique identifier to the device. With the unique identifier, the device may provide 350 that identifier to a service on the network to request a particular service. The service on the network receives the request for the particular service, verifies the unique identifier as being assigned to the particular device, and provides responsive services 360.

After the unique identifier has served its useful purpose and is otherwise no longer needed by the device, the device and/or the device identify assignor may release the unique identifier from the device and make it available for subsequent requests.

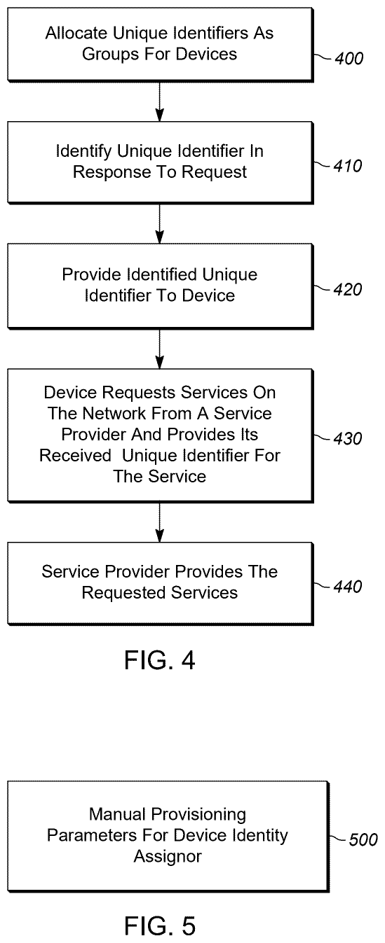

Referring to FIG. 4, for the device identity assignor to more effectively manage the unique identifiers that are assigned to various devices, it is desirable that the pool of unique identifiers are allocated 400 among the various devices as groups of unique identifiers, where there are a plurality of unique identifiers in each group 400. With the unique identifiers pre-allocated into groups, the device identify assignor provides one of the unique identifiers in response to a request from a device from the device's pool of unique identifiers 410. The device identity assignor identifies the unique identifier provided as being used by the associated device 420. With the unique identifier, the device may provide 430 that identifier to a service on the network to request a particular service. The service on the network receives the request for the particular service, verifies the unique identifier as being assigned to the particular device, and provides responsive services 440.

After the unique identifier has served its useful purpose and is otherwise no longer needed by the device, the device and/or the device identify assignor may release the unique identifier from the device and make it available for subsequent requests.

Referring to FIG. 5, the system may include at least partially manual provisioning parameters for each identified device, preferably with a set of defaults, that define a set of unique identifiers for each device on the network that may need such unique identifier(s). For example, a subset with a default size of unique identifiers may be defined for each device that include a common attribute. For example, the common attribute may include a combination of one or more of a numerical range, a common set of bits set within an integer part of the set of values, and/or a common range of characters within the set of values. The size of the identifier value subset (e.g., number of unique identifiers) may be changed as part of the provisioning process, individually and/or globally.

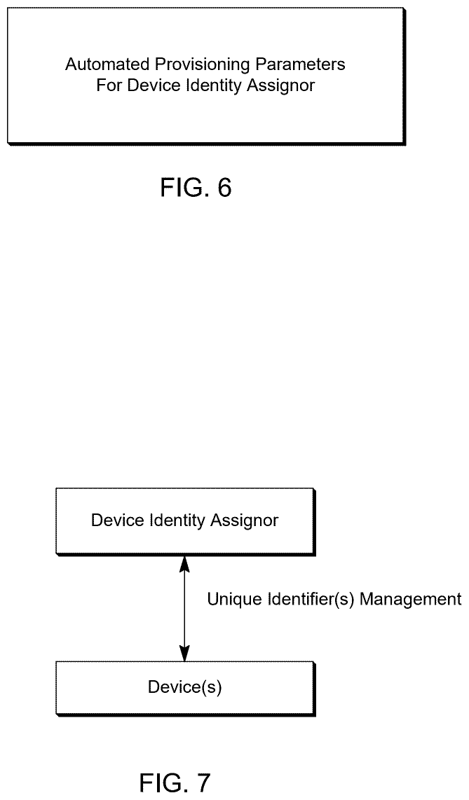

Referring to FIG. 6, the system may include automated provisioning parameters for each identified device, preferably with a set of defaults, that define a set of unique identifiers for each device on the network that may need such unique identifier(s). For example, a subset with a default size of unique identifiers may be defined for each device that include a common attribute. For example, the common attribute may include a combination of one or more of a numerical range, a common set of bits set within an integer part of the set of values, and/or a common range of characters within the set of values. The size of the identifier value subset (e.g., number of unique identifiers) may be changed as part of the provisioning process, individually and/or globally.

Referring to FIG. 7, the system may include at least partially manual and/or automated allocation of the subset of unique identifiers that are defined for each device that include a common attribute. For example, the allocation of the unique identifiers for each device may be based upon an initial request for a unique identifier from the respective device. For example, the allocation of the unique identifiers for each device may be based upon the respective device joining the network to send and receive data. Each of the devices may return one or more of the allocated set of unique identifiers to the device identify assignor when they are no longer needed. Each of the devices may re-use one or more of the allocated set of unique identifiers provided by the device identify assignor when they are needed in the future. One or more of the allocated set of unique identifiers provided may be reclaimed by the device identity assignor, especially when the respective device is no longer being provided services by the network (e.g., offline).

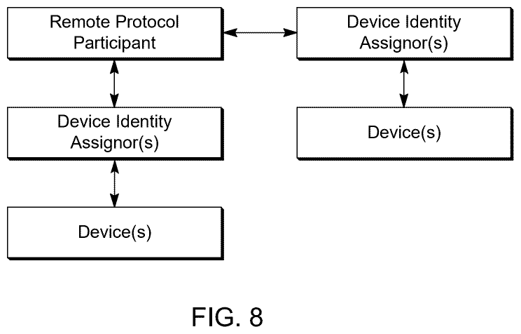

Referring to FIG. 8, the device identity assignor may assign the unique identifiers based upon information from a remote protocol participant. The remote protocol participant is separate from the device identity assignor, preferably operating on a separate computing device or otherwise in a separate process on the same computing device. The remote protocol participant may communicate with a plurality of device identity assignors, which in turn communicate with a plurality of separate devices. The allocation of unique identifiers, release of unique identifiers, and/or re-use of unique identifiers may be managed by the remote protocol participant. Also, the device identity assignor is preferably only capable of assigning the pool of unique identifiers among a plurality of devices in a manner such that none of the pool of unique identifiers are assigned to more than one device at any particular time. Other types of networks may be used, such a wide area networks, local area networks, passive optical networks etc.

In a DOCSIS based system, a gate defines a resource authorization envelope consisting of IP-level quality of service (QoS) parameters as well as classifiers defining the scope of service flows that may be established against the gate. In accordance with the DOCSIS authorization mechanisms, DOCSIS QoS signalling (DSx) requests which conform to the following general relation on a parameter-by-parameter basis should be granted: Authorized Envelope>=Reserved Envelope>=Committed Envelope. See, PacketCable Specification Multimedia Specification PKT-SP-MM-I07-15111, Nov. 11, 2015 and PacketCable 1.5 Specification Security PKT-SP-SEC1.5-I03-090624, Jun. 24, 2009, both of which are incorporated by reference herein.

Based on this policy management model, a pre-authorization scheme may include network resources that are authorized in advance of DSx messaging that requests establishment of a corresponding service flow. Consequently, a common open policy service (COPS) interface may be used to install and manage gates (e.g., a COPS-PR model defined in RFC 3084, or RFC 2748, both of which are incorporated by reference herein). Also, to install and manage these gates, a set of COPS client-specific objects which constitute the primitives of a gate control signaling interface between a call management server (CMS) and a cable modem termination system (CMTS) may be used.

The CMS may be logically decomposed into a call agent, responsible for telephony call-state maintenance, and a gate controller, which receives authorization requests from the call agent (through an internal interface) and installs policy decisions in the form of gates on the CMTS. By way of example, this decomposition may be formalized through two separate network elements, a policy server and an application manager. For example, this resource management model allows for the proxying of various steps on behalf of the endpoint through a gate control interface.

The gate is a logical representation of a policy decision that has been installed on the CMTS. The gate is used to control access by a single IP flow to enhanced QoS Services provided by a DOCSIS cable network. By way of example, gates may be unidirectional; a single gate controls access to a flow in either the upstream or the downstream direction, but not both. By way of example, for a bi-directional IP session, two gates are preferably used, one for upstream and one for downstream, each identified by a unique GateID. By way of example, a gate may be used for bi-directional IP session.

Each gate has a separate GateID. The gate defines an authorization, reservation, and committed envelopes to be used by the CMTS to perform authorization, reservation and commit operations. Accordingly, the GateID is the handle for the gate. The GateID is assigned by the CMTS and is used by the application manager, policy server, and client to reference the gate.

The GateID is an identifier that is locally allocated by the CMTS where the gate resides. The GateID is associated with only one gate. The gate and GateID relationship is preferably a one-to-one relationship which assists in supporting multimedia services.

By way of example, when the application manager issues a gate-set request, this triggers the policy server to issue a gate-set message to the CMTS. When the CMTS responds with an acknowledgment containing the GateID, the policy server forwards this response including the GateID back to the application manager. Note that since there can be a many-to-many relationship between a policy server and a CMTS, the GateID assigned by one CMTS cannot be guaranteed to be unique across the network, so the policy server may use an AMID (e.g., handle that identifies the Application Manager and Application Type) of the application manager along with a SubscriberID and the GateID in order to uniquely identify the gate. By way of example, other GateID arrangements may be used, in either a unidirectional and/or a bi-directional manner.

An algorithm that may be used to assign values of GateIDs is as follows. Partition the 32-bit word into two parts, an index part, and a random part. The index part identifies the gate by indexing into a small table, while the random part provides some level of obscurity to the value. The CMTS should attempt to minimize the possibility of GateID ambiguities by ensuring that no GateID gets reused within three minutes of its prior closure or deletion.

Among the various QoS envelope checks, the authorization block Type-Length-Value (TLV) in the DOCSIS dynamic service add (DSA) and dynamic service change (DSC) messages from the cable modem needs to match a valid (e.g., recently sent) GateID on the CMTS device. An embedded multimedia terminal adapter (eMTA), typically included within a customer premise equipment, contains an interface to a physical voice device, a network interface, various CODECs, and signaling and encapsulation function for VoIP transport, class features signaling, and/or QoS signaling. The eMTA learns the GateID from a network call signaling (NCS) of a create connection (CRCX) message from the call management server. The creation of the GateID by the CMTS maintains an assignment of GateIDs among the various consumer premise equipment. See, for example, PacketCable 1.5 Specification Security PKT-SP-SEC1.5-I03-090624.

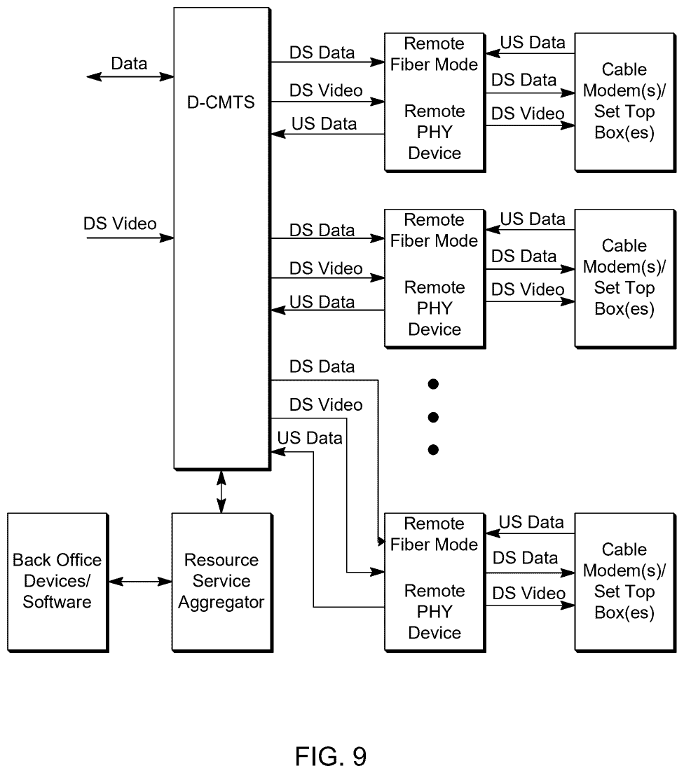

Referring to FIG. 9, the functionality provided by each of the Remote PHY (or R-PHY) which relocates the physical layer (PHY) of a traditional Integrated CCAP by pushing it to the network's fiber nodes where the corresponding MAC processing may be located within any suitable portion of the head end, or otherwise, (or R-MACPHY relocates both the MAC and the PHY to the network's nodes) operates in a similar manner to the traditional CMTS with respect to the assignment of the GateIDs. With a plurality of remote fiber nodes included within a cable network, the back office devices/services (i.e., processes), such as billing services, policy server, client management services, call management system (e.g., VoIP calls), application management, etc., are often designed from the standpoint of supporting a single integrated CMTS and are not otherwise especially suitable for operation with a distributed network including Remote PHY and/or Remote MACPHY. To further support the existing back-office devices/services (i.e., process) in a more streamlined manner the system may include a resource service aggregator to act as an aggregation point for the remote fiber nodes, at least with respect to part of the GateID related communications.

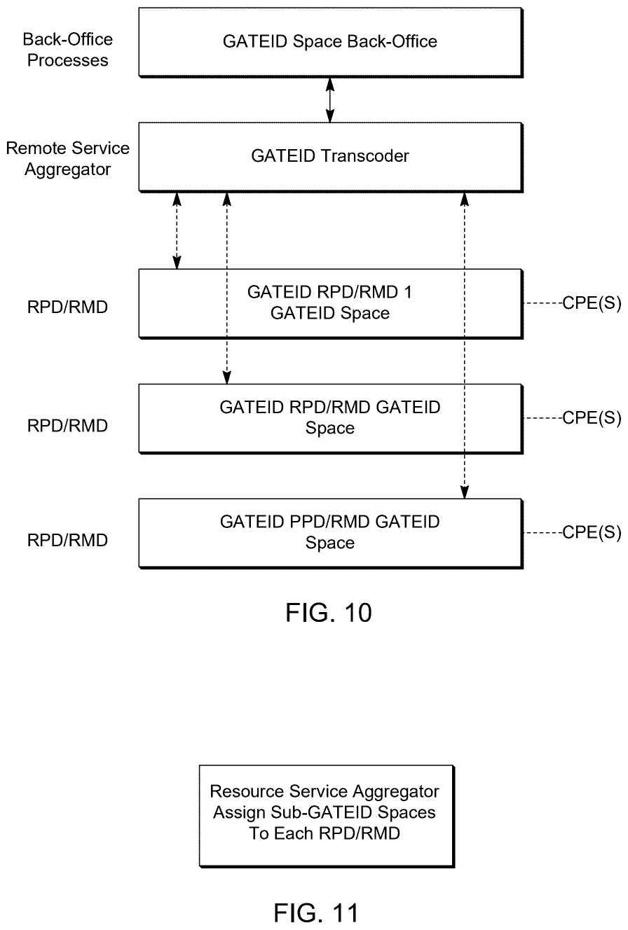

Referring also to FIG. 10, each of the RPDs/RMDs provides a corresponding one of the GateIDs to its corresponding cable modem(s)/set top box(es) (generally consumer premise equipment(s)). In this manner, each of the RPDs/RMDs may independently assign selected ones of the GateIDs to its corresponding consumer premise equipment (CPEs) from the GateID space. Each of the RPDs/RMDs provides its assigned GateIDs to a GateID manager (e.g., arbiter) included with the remote service aggregator so that the remote service aggregator can transcode (inclusive of a pass through non-modified) the received GateIDs into a non-overlapping GateID space for the back-office processes. In this manner, in the event that a plurality of the RPDs/RMDs uses the same GateID for its corresponding CPE(s), then the GateID manager can include a source identifier together with the GateID so that the GateID can be uniquely identified with a particular RPD/RMD and a corresponding CPE. Also, the GateID manager may map overlapping GateIDs to unique unused GateIDs within the GateID space presented to the back-office processes. In a similar manner, when the back-office processes provide the GateID to a corresponding RPD/RMD, the GateID manager reverses the transcoding process to provide the GateID to the appropriate RPD/RMD, even in the case that the particular GateID is used by a plurality of RPD(s)/RMD(s) within the system. Further, the GateIDs may be re-used and/or changed to unassigned by the RPD(s)/RMD(s) and providing such updated information to the back-office processes through the GateID manager of the remote service aggregator. As it may be observed, the overall set of GateIDs appears uniquely within the GateID space to the back-office processes so that even with a pluralitiy of RPDs/RMDs that may use overlapping GateIDs, all the GateIDs are presented to the back-office processes as a single unified GateID space. The GateIDs are used as an authorization tolkien, as previously described. The GateIDs are selectively provided by the back-office processes to the consumer premise equipment as an authorization tolkien for channel services that the consumer premise equipment desires to use, such as VoIP services.

Preferably, the remote service aggregator is operating on a cloud-based server, a domain manager, and/or one or more other devices within the network.

After further analysis is was determined that the back-office processes, using the GateID provided by the remote service aggregator, selectively provides the GateID to the corresponding CPE for enhanced services using an out of band signaling using the data path of the D-CMTS and/or the RPD/RMD. In particular, the GateID is typically provided to the eMTA within the CPE using the out of band signaling. By way of example, a call management server may provide the GateID directly to the corresponding eMTA of a CPE using the out of band signaling using the data path of the D-CMTS and/or the RPD/RMD. In this manner of communication, the GateID is not transcoded by the remote service aggregator when it is being provided to the eMTA of the CPE, nor is the GateID being provided to the D-CMTS for modifying its configuration nor the RPD/RMD for modifying its configuration. The CPE then provides the GateID received from the back-office process to its corresponding RPD/RMD as a tolkien for enhanced services to authorize the services, such as a VoIP call.

By way of example, the call management server may signal the RPD/RMD about an enhanced service that is likely to be requested, such as setting up a VoIP call, together with parameters for the enhanced service, and that the RPD/RMD may expect to receive a request from the eMTA of the CPE having a set of characteristics. The RPD/RMD in response provides the GateID to the call management server that should be used to validate the enhanced services. The call management server receives the GateID from the RPD/RMD, then using an out of band signaling technique signals the eMTA of the CPE with information to set up the enhanced services together with the GateID. The eMTA of the CPE then requests the enhanced services from the corresponding RPD/RMD using the GateID.

In the case that the GateID manager passes the corresponding GateID in a pass through non-modified manner, then the GateID maintained by the RPD/RMD will be the same as the GateID provided by the CPE that was received from the back-office process. Accordingly, the GateID provided to the RPD/RMD from the CPE matches the GateID maintained by the RPD/RMD, and the RPD/RMD in response provides the enhanced service, such as a VoIP call.

In the case that the GateID manager passes the corresponding GateID in a transcoded manner, then the GateID maintained by the RPD/RMD will not be the same as the GateID provided by the CPE that was received from the back-office process. Accordingly, the GateID provided to the RPD/RMD from the CPE fails to match the GateID maintained by the RPD/RMD, and the RPD/RMD in response will not provide the enhanced service, such as a VoIP call.

The signaling of the GateID may be modified such that the back-office processes reverses the transcoding of the GateID prior to it being provided to the eMTA of the CPE. By way of example, this may take the form of a modification in the signaling path through the GateID manager to the eMTA of the CPE. By way of example, this may take the form of inspecting each data packet from the back-office process for such out of bound GateID messages, modification of the GateID of such data packet(s), and then providing the modified GateID to the eMTA of the CPE. While either of these processes are acceptable, they incur additional computational burden on the system.

Referring to FIG. 11, another technique may be based upon ensuring that there are no overlapping GateIDs being used by the plurality of RPD/RMD. The system, or otherwise the resource service aggregator, may assign a sub-portion of the total GateID space to each of the RPDs/RMDs, that are available for use. In this manner, when each of the RPDs/RMDs select a GateID, each of them is selected from a corresponding non-overlapping sub-portion of the total GateID space. Accordingly, each of the GateIDs that is selected by any of the RPDs/RMDs within the network is guaranteed to be non-overlapping.

One exemplary technique for achieving this separation of the GateID space among the RPDs/RMDs may be based upon the following. A policy enforcement point identification object (PEPID) as defined in RFC 2748 (COPY) as a variable length field. It is a NULL terminated ASCII string that is also zero padded to a 32-bit word boundary (so the object length is a multiple of 4 octets). The PEPID contains an ASCII string that uniquely identifies the policy enforcement point (PEP) within the policy domain in a manner that is persistent across PEP reboots.

Moreover, each functional block or various features in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A network system comprising:
(a) a remote device that maintains a pool of GateIDs, where each of said GateIDs is suitable to be provided to a provider of a call service of said network;
(b) said remote device assigning a set of GateIDs to a device, were all of said set of GateIDs is not currently assigned to any other device;
(c) said remote device not assigning any of said set of GateIDs to said any other device while a corresponding one of set of GateIDs is assigned to said device;
(d) where said remote device is only capable of assigning said pool of GateIDs among a plurality of devices in a manner such that none of said pool of GateIDs are assigned to more than one device at any particular time.

2. The network system of claim 1 wherein said remote device said set of GateIDs to said device in response to a request from a device.

3. The network system of claim 1 wherein said remote device said set of GateIDs to said device automatically.

4. The network system of claim 1 further comprising said provider of said service receiving one of said assigned GateIDs of said set of GateIDs from said device.

5. The network system of claim 4 wherein said network system provides said service to said device upon verification of said one of said assigned GateIDs being assigned to said device.

6. The network system of claim 1 wherein said remote device releases one of said set of GateIDs from being assigned to said device and assigns said one of said set of GateIDs to a different device.

7. The network system of claim 1 wherein said remote device assigns said set of GateIDs to include a common attribute.

8. (canceled)

9. The network system of claim 7 wherein said common attribute includes a common set of bits set within an integer part of the set of values.

10. The network system of claim 7 wherein said common attribute includes a common range of characters within the set of values.

11. (canceled)

12. (canceled)

13. A network system comprising:
(a) a remote device that maintains a pool of GateIDs, where each of said GateIDs is suitable to be provided to a provider of a service of said network;
(b) said remote device associating a GateID of said pool of GateIDs with a device, were said GateID is not currently associated to any other device;
(c) said remote device not associating said GateID to said any other device while said GateID is associated with said device;
(d) where said remote device is only capable of associating each of said pool of GateIDs among a plurality of devices in a manner such that none of said pool of GateIDs are associated to more than one device at any particular time.

14. A network system comprising:
(a) a device identity assignor that maintains a pool of unique identifiers, where each of said unique identifiers is suitable to be provided to a provider of a service of said network to receive said service;
(b) said device identity assignor assigning a set of unique identifiers to a device, were all of said set of unique identifiers is not currently assigned to any other device;
(c) said device identity assignor not assigning any of said set of unique identifiers to said any other device while a corresponding one of set of unique identifiers is assigned to said device;
(d) where said device identity assignor is only capable of assigning said pool of unique identifiers among a plurality of devices in a manner such that none of said pool of unique identifiers are assigned to more than one device at any particular time.

15. The network system of claim 14 wherein said device identity assigns said set of unique identifiers to said device in response to a request from a device.

16. The network system of claim 14 wherein said device identity assigns said set of unique identifiers to said device automatically.

17. The network system of claim 14 further comprising said provider of said service receiving one of said assigned unique identifiers of said set of unique identifiers from said device.

18. The network system of claim 17 wherein said network system provides said service to said device upon verification of said one of said assigned unique identifiers being assigned to said device.

19. The network system of claim 14 wherein said device identity assignor releases one of said set of unique identifiers from being assigned to said device and assigns said one of said set of unique identifiers to a different device.

20. The network system of claim 14 wherein said device identity assignor assigns said set of unique identifiers to include a common attribute.

21. (canceled)

22. The network system of claim 20 wherein said common attribute includes a common set of bits set within an integer part of the set of values.

23. The network system of claim 20 wherein said common attribute includes a common range of characters within the set of values.

24. A network system comprising:
(a) a device identity assignor that maintains a pool of unique identifiers, where each of said unique identifiers is suitable to be provided to a provider of a service of said network;
(b) said device identity assignor associating a unique identifier of said pool of unique identifiers with a device, were said unique identifier is not currently assigned to any other device;
(c) said device identity assignor not associating said unique identifier to said any other device while said unique identifier is associating with said device;
(d) where said device identity assignor is only capable of associating eachof said pool of unique identifiers among a plurality of devices in a manner such that none of said pool of unique identifiers are associating to more than one device at any particular time.
